(19) United States
(12) Patent Application Publication
(10) Pub. No.: US 2026/0336747 A1
(43) Pub. Date: Oct. 29, 2026

(54) MOTORCYCLE CONNECTING STRAP

(71) Applicant: Eric Michael Landis, Grand Junction, CO (US)

(72) Inventor: Eric Michael Landis, Grand Junction, CO (US)

(21) Appl. No.: 19/187,955

(22) Filed: Apr. 23, 2025

(51) Int. Cl. B62K 27/10

(52) U.S. Cl. CPC B62K 27/10

(57) ABSTRACT

Aspects of the present disclosure may be directed to a towing assembly for connecting a first motorcycle to a second motorcycle. In some aspects, the towing assembly may include: a tow strap including a body portion having a first end loop and an opposing second end portion, the body portion being formed of a webbing material; a peg strap assembly threaded through the first end loop, the peg strap assembly including at least one adjustable loop at a distal end, the at least one adjustable loop being configured to securely engage a foot peg of the first motorcycle; and a fork-frame strap portion configured to attach the opposing second end portion of the body portion to a structural component of the second motorcycle.

### BACKGROUND

Participation in outdoor activities often involves the coordination of multiple participants or vehicles. In many scenarios, it may be necessary or beneficial to link one participant or vehicle with another for safety, convenience, or to enable a combined effort. For instance, certain activities can be more enjoyable or feasible when a stronger participant helps tow or guide another participant who is less experienced. Alternatively, two vehicles of different power levels or conditions may travel together, requiring a mechanism to maintain connection or to facilitate towing.

Traditional methods of linking participants or vehicles have taken various forms, including ropes, rigid bars, or flexible straps. However, each approach presents challenges: ropes may be prone to tangling or sudden jerks, bars can be cumbersome or unwieldy, and ordinary straps may lack adjustability or secure anchoring features. Moreover, ensuring reliable attachment and minimizing interference with the normal operation of the vehicles or equipment are important considerations. In many cases, the connecting mechanism must be easily attachable and removable so that participants can separate quickly when circumstances change. These considerations underscore the need for improved solutions that address the typical shortcomings of conventional connecting or towing systems.

### SUMMARY

Aspects of the present disclosure are directed to improved connection systems and assemblies that facilitate the towing or linking of two vehicles—such as motorcycles, bicycles, or other conveyances—or a vehicle and an object to be pulled. In some implementations, aspects describe a flexible yet secure attachment that can be quickly configured for different sizes, types, or styles of vehicles, enabling a broad range of towing or guiding scenarios.

Certain aspects of the disclosed technology involve a towing assembly for connecting a first motorcycle to a second motorcycle, allowing for adjustable and reliable connections at key structural points of one or more motorcycles. In one implementation, the towing assembly may include a body portion, where the body portion may include at least one loop through which a separate component can be threaded, creating a secure junction between a leading vehicle and a trailing vehicle or object. Other aspects may utilize specialized straps or loops, configured to attach to elements such as foot pegs, frames, or forks, enhancing safety of a towing operation by keeping the towing assembly clear of wheels and other moving parts.

Additional features of the disclosed systems may include elastic or inextensible strap options for customized tension control, protective sleeves that shield load-bearing materials from abrasion, and reinforced stitching at high-stress junctures. In some aspects, the elastic strap may include elastic band may having a solid, polygonal cross-sectional shape. The cross-sectional shape of the material may be, for example, square or rectangular.

In some implementations, a webbing sleeve covering the elastic band is configured for a maximum elongation of 4:1 and the elastic band is configured for a maximum elongation of 7:1. The elastic band may be formed of a natural rubber or thermoplastic elastomer, for example, of dipped natural latex. In some cases, the elastic band is configured to pull no more than 18 pounds of weight, for example, no more than 15 pounds of weight, before the webbing sleeve engages and takes the load. The webbing sleeve may be configured to prevent the rubber from being over stretched as well as protecting the rubber from UV damage. The webbing sleeve may be formed of polypropylene or nylon.

In certain examples a peg strap assembly and the body portion of the tow strap may be made of a substantially inextensible material. For example, the peg strap assembly may be made of a nylon or woven polypropylene webbing. In some examples, the peg strap assembly has a width of approximately one inch and a thickness in a range of 0.070 to 0.075 inches. In one example, the peg strap assembly has a breaking strength of 3000 pounds. The peg strap assembly may be made of the same material as the tow strap or a different material. These and other embodiments of the disclosed concepts are described in more detail below, and it will be appreciated that the various features, components, and methods introduced herein can be integrated in different combinations to address diverse towing needs.

Still other aspects, embodiments, and advantages of these exemplary aspects and embodiments are discussed in detail below. Embodiments and implementations disclosed herein may be combined with other embodiments and implementations in any manner consistent with at least one of the principles disclosed herein.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments and are incorporated in and constitute a part of this specification but are not intended as a definition of the limits of the invention. In the figures, each identical or nearly identical component that is illustrated in various figures is represented by a like numeral. For purposes of clarity, not every component may be labeled in every figure. In the figures:

FIG. 1 depicts a perspective view illustrating a towing scenario in which a first motorcycle serves as the leading conveyance and a second motorcycle follows behind, connected by a tow strap assembly in accordance with examples of the present disclosure.

FIG. 2 depicts a detailed perspective view of a peg strap assembly that may be used with the tow strap assembly of FIG. 1, showing an adjustable peg loop configured to engage a motorcycle foot peg in accordance with examples of the present disclosure.

FIG. 3 depicts a side view of the towing configuration attached to the first motorcycle in accordance with examples of the present disclosure.

FIG. 4 depicts a detailed perspective view of an example of the tow strap assembly, illustrating transition portions between elastic (bungee) material and flat webbing, as well as various attachment loops in accordance with examples of the present disclosure.

FIG. 5 depicts a perspective view of an example of the tow strap assembly having an elastic or bungee-type body portion, illustrating how the strap transitions into connecting portions at either end in accordance with examples of the present disclosure.

FIG. 6 depicts another perspective of the tow strap assembly of FIG. 5 in accordance with examples of the present disclosure.

FIG. 7 depicts a perspective view of a different example of the tow strap assembly configured primarily from flat webbing in accordance with examples of the present disclosure.

FIG. 8 depicts yet another example of the tow strap assembly featuring a single continuous loop at one end of the flat webbing in accordance with examples of the present disclosure.

### DETAILED DESCRIPTION

Aspects and embodiments are directed to connection systems, including one or more connection straps and methods of attaching the connection strap(s), that allow two persons to engage in a joint sporting activity or allow a person to tow an object.

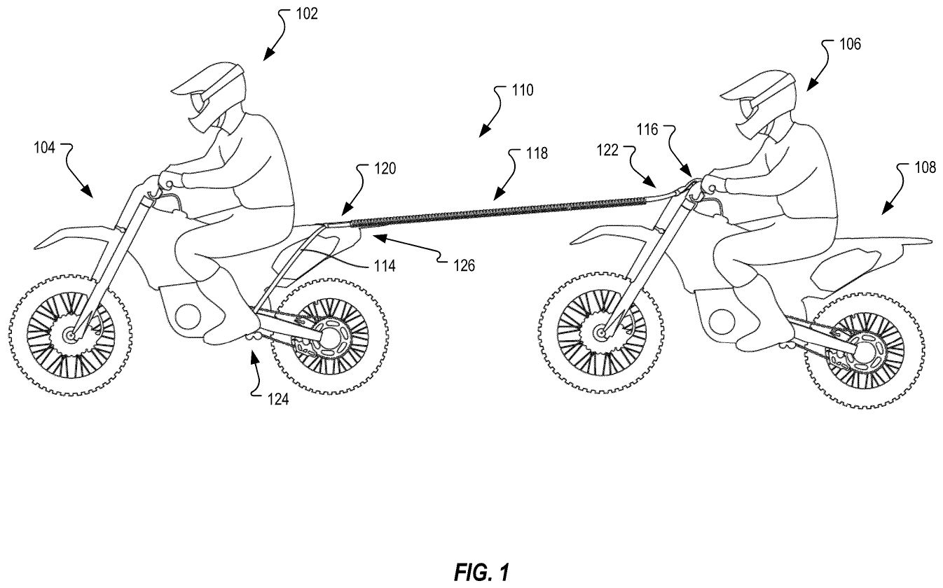

FIG. 1 illustrates a tow strap assembly 110 adapted for use with motorcycles or similar conveyances in accordance with examples of the present disclosure. As depicted in FIG. 1, a first user 102 may be positioned upon a first motorcycle 104, serving as the leading conveyance in a towing scenario. The first motorcycle 104 may be any suitable motorized vehicle such as a dirt bike, motorcycle, or comparable motorized conveyance capable of transporting the first user 102 during travel. A second user 106, riding or otherwise associated with a second motorcycle 108, follows behind and is positioned as the trailing vehicle. In some aspects, the tow strap assembly 110 extends between the first motorcycle 104 and the second motorcycle 108, enabling the lead vehicle (e.g., first motorcycle 104) to provide towing assistance to the second motorcycle 108 or otherwise facilitate combined travel.

In some aspects, the tow strap assembly 110 may include multiple interconnected elements. For example, the tow strap assembly 110 may include a tow strap 112, a peg strap assembly 114, and a fork/frame strap 116. Each of the tow strap 112, a peg strap assembly 114, and a fork/frame strap 116 of the tow strap assembly 110 may be configured to provide secure and adjustable attachment points for reliable and efficient towing between the first motorcycle 104 and second motorcycle 108. The tow strap assembly 110 may be versatile and capable of accommodating varying sizes, designs, and configurations of motorcycles. In some aspects, one or more variations to the tow strap assembly 110 may include but are not limited to, using elastic (bungee-type) or substantially inelastic (flat webbing) strap configurations to suit different towing preferences, needs, and operational conditions.

In some examples, the tow strap assembly 110 may be provided as part of a multi-piece kit. For instance, a tow kit may include (i) a tow strap featuring a tubular sleeve and internal band, (ii) a universal peg strap assembly, and (iii) a universal fork/frame strap. Another kit may include a flat webbing tow strap (very little stretch) plus the same universal peg strap and fork/frame strap. Alternatively, a kit may use a flat webbing tow strap and a universal peg strap, with a hitch-through-itself loop for the fork or frame of the trailing motorcycle.

In some aspects, the tow strap 112 may include a body portion 118, which may span a distance between the first motorcycle 104 and the second motorcycle 108. The body portion 118 may comprise durable webbing or an elastic material capable of elongation under load, thus absorbing tension and providing controlled towing dynamics by dampening abrupt changes in force between the first motorcycle 104 and second motorcycle 108. In some examples, the body portion 118 may comprise tubular webbing encasing an elastic band, facilitating elongation under tension to dampen abrupt forces encountered during towing. This property helps maintain smooth tensioning, reducing the potential for uncomfortable or dangerous jerks during use. Alternatively, the body portion 118 may comprise a flat webbing construction, where elasticity is minimal or not provided, relying instead on the inherent flexibility of the webbing material itself. The body portion 118 may transition directly into the first connecting portion 120 and the second connecting portion 122 or interface indirectly through additional components or coupling devices.

In some aspects, the webbing for the body portion 118 and other strap elements can be formed of 1 ¼-inch wide tubular (hollow) webbing, commonly made of nylon or polypropylene, often exhibiting a breaking strength in the range of about 2,000-3,000 lbs. When configured as an elastic (bungee-type) strap, the relaxed length of the body portion 118 may be approximately 72 inches, with an extension under tension of up to about 192 inches. In a flat webbing (non-elastic) version, the length may be about 180 inches overall, with loops at each end sized at approximately 5 inches. In some aspects, a short stitch (e.g., about 2 inches) may be placed near the mouth of the loop to help secure or position peg straps or other attachments without unnecessary sliding.

In some aspects, the first connecting portion 120 extends from one end of the body portion 118 of the tow strap assembly 110 and may be configured for secure attachment to the leading, first motorcycle 104. The first connecting portion 120 may include a distal end configured into an end loop, optionally having multiple openings for versatile attachment means, including direct looping, threading, or connection to coupling devices like carabiners or hooks. In some examples, the first connecting portion 120 directly transitions from the flat-webbing configuration of the body portion 118 into the end loop without intermediate segments. Alternatively, an additional strap length may be positioned between the loop and the body portion 118, increasing reach or enabling adjustments in strap length. In some aspects, the first connecting portion 120 may directly receive or couple with the peg strap assembly 114, simplifying the attachment method and reducing bulk. Coupling devices, such as carabiners, buckles, or quick-release connectors, may also be employed at this portion for fast and efficient assembly or removal from the first motorcycle 104.

In some aspects, the second connecting portion 122 may extend from an opposite end of the body portion 118 and may provide an attachment to the trailing second motorcycle 108. Similar to the first connecting portion 120, the second connecting portion 122 may also comprise an end loop and optionally an intermediary strap length. In some aspects, the second connecting portion 122 may directly transition into a fork/frame strap 116. The fork/frame strap 116 may facilitate the connection of the tow strap assembly 110 to structural or frame components of the trailing, second motorcycle 108, such as handlebars or forks. In various implementations, the second connecting portion 122 can include a coupling device, such as a carabiner, to secure the attachment of the second connecting portion 122 to the fork/frame strap 116.

In some aspects, the peg strap assembly 114 may include multiple functional features enhancing attachment reliability to the first motorcycle 104. The peg strap assembly 114 may comprise at least one peg strap portion with an adjustable loop at its distal end. In certain aspects, two peg strap portions may be integrally formed from a single continuous length of strap material, each equipped with adjustable peg loops adapted to securely engage corresponding foot pegs 124 of the first motorcycle 104. The adjustability of the adjustable peg loops may be provided by using securing elements, such as buckles or tension locks, allowing the loop size to be adapted to various foot peg dimensions or structural configurations. Additionally, one or more protective sleeves may be disposed on the adjustable peg loops to prevent abrasion or damage from sharp edges, for instance. In some aspects, the adjustable peg loops can facilitate a firm, slip-resistant coupling that effectively transfers towing forces directly to structural elements of the motorcycle frame to increase safety and durability during use.

In some aspects, a universal peg strap may include adjustable buckles to fit a wide range of bikes, from small dirt bikes to large street bikes. It may integrate a protective sleeve covering the foot peg contact area to preserve the underlying webbing. This peg strap can be provided as a standalone upgrade for existing tow systems.

In some aspects, the foot pegs 124 of the first motorcycle 104 may act as structural attachment points for the peg strap assembly 114. In some aspects, these foot pegs 124 provide robust anchoring points that reliably withstand substantial tension forces exerted by the tow strap assembly 110. Positioned low on the motorcycle's frame and spaced symmetrically, these foot pegs 124 can facilitate a balanced distribution of pulling forces transmitted through the peg strap assembly 114. Because foot pegs 124 may be designed and secured to bear substantial rider loads during operation and maneuvering, the foot pegs 124 can provide an anchor point, contributing to the overall stability and security of the towing configuration.

In some aspects, the tow strap assembly 110, particularly the first connecting portion 120 and peg strap assembly 114, may be advantageously routed over or positioned upon the tail section 126 of the first motorcycle 104. The tail section 126 of the first motorcycle 104 may refer broadly to one or more structural components, including but not limited to the rear fender, rear mudguard, rear fairing, or a rearward extending portion of the motorcycle. Accordingly, with the tow strap assembly 110 routed over or positioned upon the tail section 126, the tow strap assembly 110 can be elevated and maintained such that it is clear from moving or rotating components, such as the rear wheel assembly (e.g., wheel and/or tire), drivetrain, or suspension elements, thereby minimizing the risk of interference, entanglement, or friction-induced damage during towing operations. Positioning the strap assembly this way may facilitate quick and simple attachment and detachment procedures.

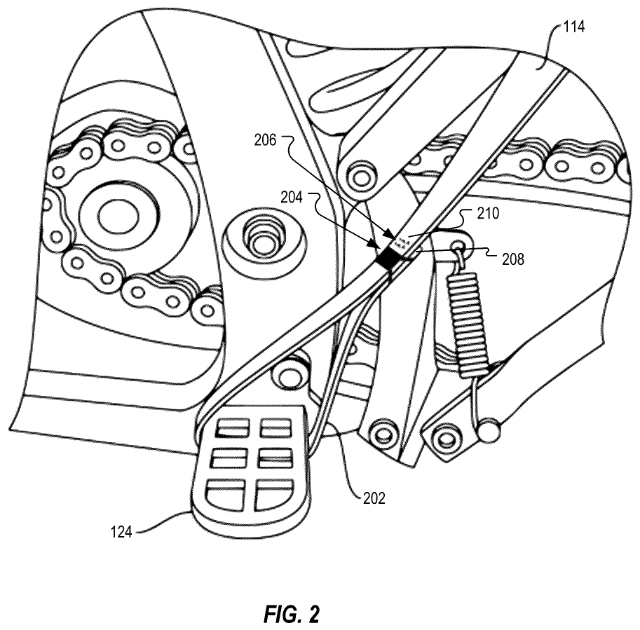

FIG. 2 depicts a detailed view of a peg strap assembly 114 associated with the tow strap assembly 110, according to at least one example of the present disclosure. In some aspects, the peg strap assembly 114 may include an adjustable peg loop 202, configured to securely engage a foot peg 124 of a first motorcycle 104 (FIG. 1). The adjustable peg loop 202 may be configured to provide adaptability for engaging foot pegs 124 of varying dimensions and shapes. Accordingly, the adjustable peg loop 202 may accommodate different motorcycle configurations. The adjustable peg loop 202 may facilitate secure and reliable attachment by maintaining stable positioning during towing scenarios. In some examples, the adjustable nature of the adjustable peg loop 202 allows precise tightening or loosening around the foot peg 124, enhancing the ease of use, especially in conditions where rapid or convenient attachment and detachment may be advantageous.

The adjustable peg loop 202 may be selectively adjusted via an adjustable securing component 204. In some examples, the adjustable securing component 204 may comprise a buckle, slide buckle, tension lock, or similar securing device capable of reliably adjusting and maintaining the size of the adjustable peg loop 202. The adjustable securing component 204 allows users to quickly adapt the length or tension of the adjustable peg loop 202 to fit a given motorcycle peg configuration. The adjustable securing component 204 may withstand large tension forces without slipping or inadvertent release. Additionally, the adjustable securing component 204 may enable incremental adjustment, providing more precision in loop sizing.

In some aspects, stitching 206 may optionally secure a distal end 208 of a peg strap portion 210 to a selected location along the peg strap portion 210. Stitching 206 may comprise reinforced stitching methods, such as bar tack stitching, configured to maintain high strength and reliability. While the stitching 206 can optionally reinforce specific positioning and stability of the peg strap portion 210, the primary securing mechanism remains the adjustable securing component 204, thus permitting adjustability. The peg strap portion 210 is preferably constructed of durable, high-strength material such as woven nylon or polypropylene webbing, providing robust load-bearing capabilities and resistance to abrasion and wear during use. The peg strap portion 210 may exhibit sufficient flexibility and pliability to allow smooth adjustment and secure engagement with foot pegs 124.

A distal end 208 of the peg strap portion 210 may be configured to interface directly with the adjustable securing component 204. In certain aspects, the distal end 208 of the peg strap portion 210 may be configured or treated to minimize wear or damage when repeatedly threaded through or engaged with the adjustable securing component 204. This distal end 208 may be finished, coated, or reinforced to enhance durability under repeated adjustments or tension loads.

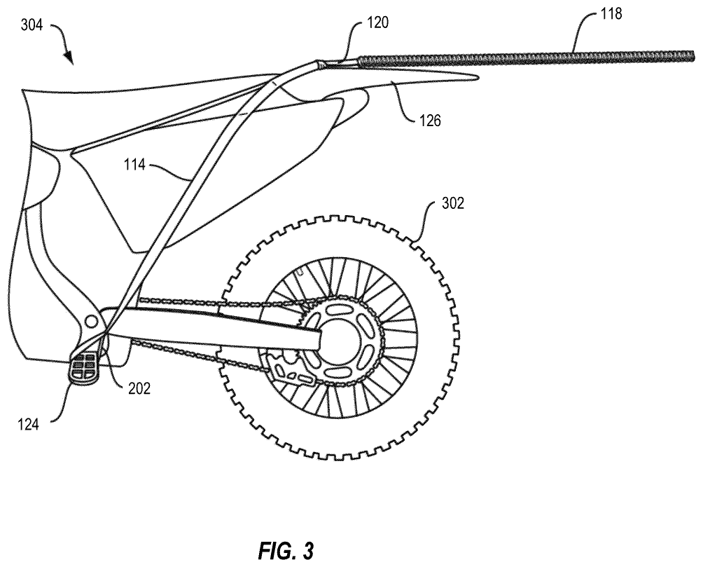

FIG. 3 illustrates a side view of a towing configuration, providing additional attachment details associated with the first motorcycle 104 (FIG. 1) in accordance with aspects of the present disclosure. As shown in FIG. 3, the peg strap assembly 114 may extend downward from the tow strap assembly (not fully shown in FIG. 3) and securely engages with the foot peg 124 through the adjustable peg loop 202 previously described with reference to FIG. 2. The adjustable peg loop 202 facilitates the peg strap assembly 114 to remain reliably secured to the foot peg 124, allowing effective transmission of towing forces from the tow strap assembly 110 to the first motorcycle 104.

The first motorcycle 104 includes a wheel or tire 302, positioned toward the rear portion of the motorcycle. In some aspects, the wheel or tire 302 may represent a typical motorcycle component or a similar conveyance component. The wheel or tire 302 may be configured to facilitate rotational movement, enabling the vehicle's propulsion during travel. The tow strap assembly 110 may be routed above and clear from the wheel or tire 302, minimizing potential interference or entanglement during towing scenarios.

A seat 304 of the first motorcycle 104 may be positioned above the wheel or tire 302. The seat 304 may be provided as a support surface for the first user 102. It may also support or guide the tow strap assembly 110 in a raised position relative to moving parts of the first motorcycle 104, further facilitating clear and safe operation. In some aspects, seat 304 may contribute to the overall functionality and safety of the towing configuration by maintaining appropriate spacing between the tow strap assembly 110 and moving components of the motorcycle.

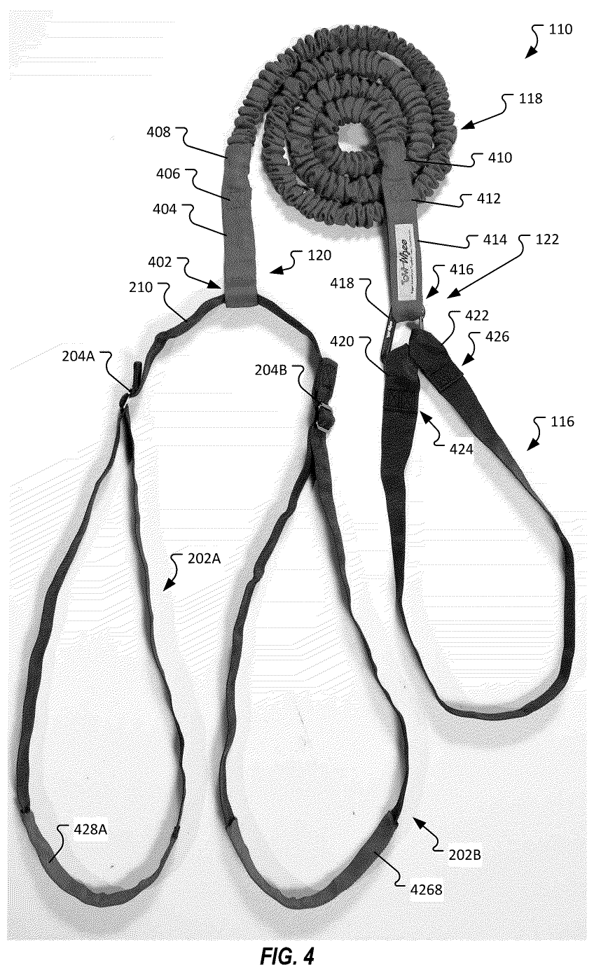

FIG. 4 illustrates additional details of an embodiment of the tow strap assembly 110 in accordance with aspects of the present disclosure. In some aspects, the tow strap assembly 110 may include a tow strap with a body portion 118 configured as an elastic bungee-type strap, facilitating elongation under tension for improved towing dynamics. In some aspects, the body portion 118 may transition at a first transition portion 408 and a second transition portion 410 into respective flat webbing portions. These transition portions 408 and 410 may include stitching 406 and 412 to secure the transition from elastic (bungee) material to flat webbing material, thus providing strength and durability at various stress points.

In some aspects, the first connecting portion 120 may include an end loop defined by a first opening 402 and optionally a second opening 404, allowing versatile attachment possibilities. The second connecting portion 122 may similarly include an end loop comprising at least one opening, designated as first opening 416, and optionally a second opening 414. This second connecting portion 122 may also incorporate a coupling device 418, such as a carabiner, for secure and efficient attachment to other strap elements, such as the fork/frame strap 116.

In some aspects, the fork/frame strap 116 may include a first-end portion 420 and a second-end portion 422. In some aspects, secure stitching 424 and 426 may form a first loop at the first end, 420, and a second loop at the second end, 422. In some aspects, the first and second loops may be coupled to the second connecting portion 122 via the coupling device 418. In some aspects, the fork/frame strap 116 may be configured for attachment to structural or frame components of a second motorcycle 108, facilitating secure coupling between the tow strap assembly 110 and the second motorcycle 108 during towing.

In some aspects, the peg strap assembly 114 includes first and second adjustable peg loops 202A and 202B, each having adjustable securing components 204A and 204B. In some aspects, each adjustable peg loop 202A and 202B may include reinforced sections 428A and 428B at distal ends, enhancing durability and resistance to wear or abrasion when attached to motorcycle foot pegs.

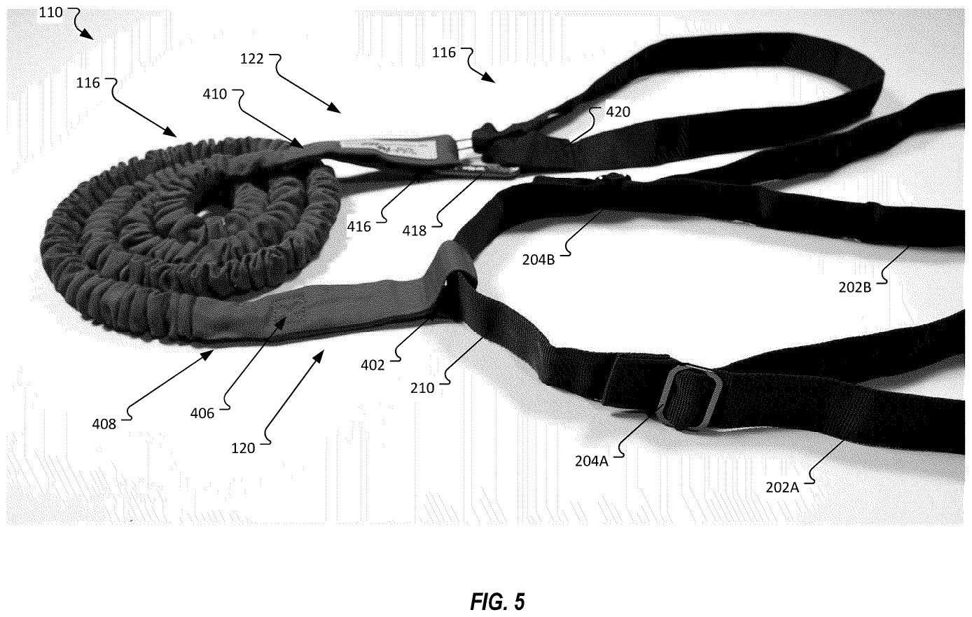

FIG. 5 illustrates an embodiment of the tow strap assembly 110 according to examples of the present disclosure. In some aspects, the tow strap assembly 110 may include a body portion 118 comprising an elastic or bungee-type configuration, enabling controlled elongation under tension during towing scenarios. The body portion 118 may transition into a first connecting portion 120 and a second connecting portion 122. The transition area (e.g., first transition portion 408 and second transition portion 410) may be reinforced with stitching 406 for enhanced durability. The first connecting portion 120 may include at least a first opening 402, facilitating attachment to various motorcycle components or additional connecting elements. For example, the peg strap portion 210 may be threaded through the first opening 402.

The second connecting portion 122 similarly comprises an end loop with an opening 416 and may incorporate a coupling device 418, such as a carabiner, providing secure and rapid connection capabilities. The coupling device 418 may be configured to facilitate easy engagement and disengagement from other strap elements, such as the fork/frame strap 116.

As further depicted in FIG. 5, the fork/frame strap 116 may include an end portion 420 configured for secure attachment to the second connecting portion 122 via the coupling device 418. Alternatively, or in addition, the fork/frame strap 116 may be threaded through the opening 416. In some aspects, adjustable peg loops 202A and 202B, with adjustable securing components 204A and 204B, provide versatility by accommodating different motorcycle foot peg configurations and maintaining secure connections during towing operations.

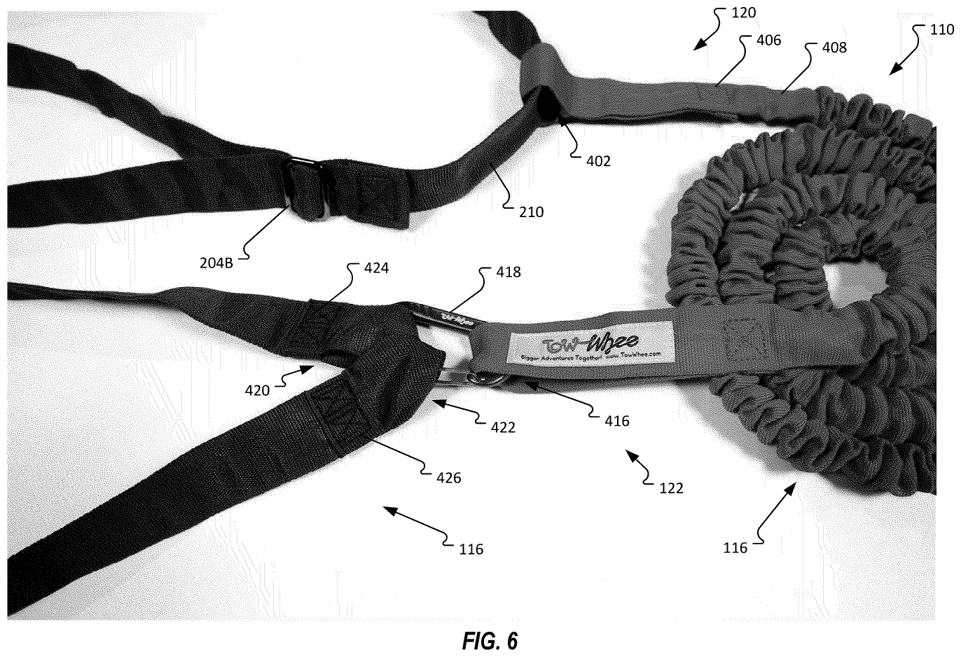

FIG. 6 shows another perspective of the tow strap assembly 110 embodiment depicted in FIG. 5, highlighting additional details and elements of the assembly in accordance with aspects of the present disclosure. As shown in FIG. 6, the coupling device 418 is depicted as being attached to the second connecting portion 122 and the fork/frame strap 116. Stitching areas 424 and 426 are more distinctly visible, reinforcing various attachment points within the assembly. Additionally, FIG. 6 further depicts adjustable securing components 204B and adjustable peg loops 202B, demonstrating their adjustability given motorcycle foot pegs.

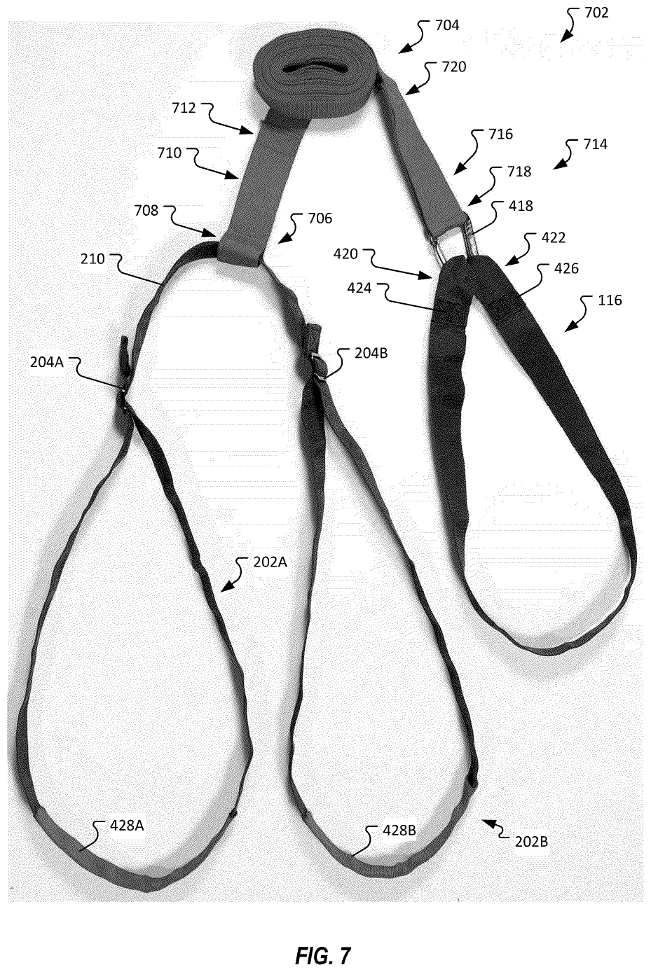

FIG. 7 depicts another example of the tow strap assembly 702 according to examples of the present disclosure. In some aspects, the tow strap assembly 702 includes a central body portion 704 comprising flat webbing. In some aspects, flat webbing may refer to a woven textile material, typically manufactured from synthetic fibers such as nylon or polypropylene. The flat webbing configuration may exhibit substantial strength and durability, is generally resistant to stretching under load, and offers a relatively thin and compact profile beneficial for lightweight storage and portability.

The first connecting portion 706 may include an end loop characterized by at least one opening, designated as the first opening 708, and may optionally include a second opening 710. These openings facilitate attachment flexibility and allow secure connections to motorcycle components through various attachment methods or coupling devices. For example, the peg strap portion 210 may be threaded through the first opening 708. Reinforced stitching 712 may be employed at various points of the first connecting portion 706 for structural reliability.

The second connecting portion 714 of the tow strap assembly 702 similarly includes an end loop, comprising at least a first opening 718 and optionally a second opening 716. Stitching 720 may reinforce the structure, enhancing durability at points subject to tension. Additionally, the second connecting portion 714 may include a coupling device 418, such as a carabiner, allowing connection with elements such as the fork/frame strap 116.

The fork/frame strap 116, having end portions 420 and 422, may include reinforced stitching 424 and 426. In some aspects, the adjustable peg loops 202A and 202B, fitted with adjustable securing components 204A and 204B, and reinforced sections 428A and 428B, can maintain adaptability and secure attachment to motorcycle foot pegs.

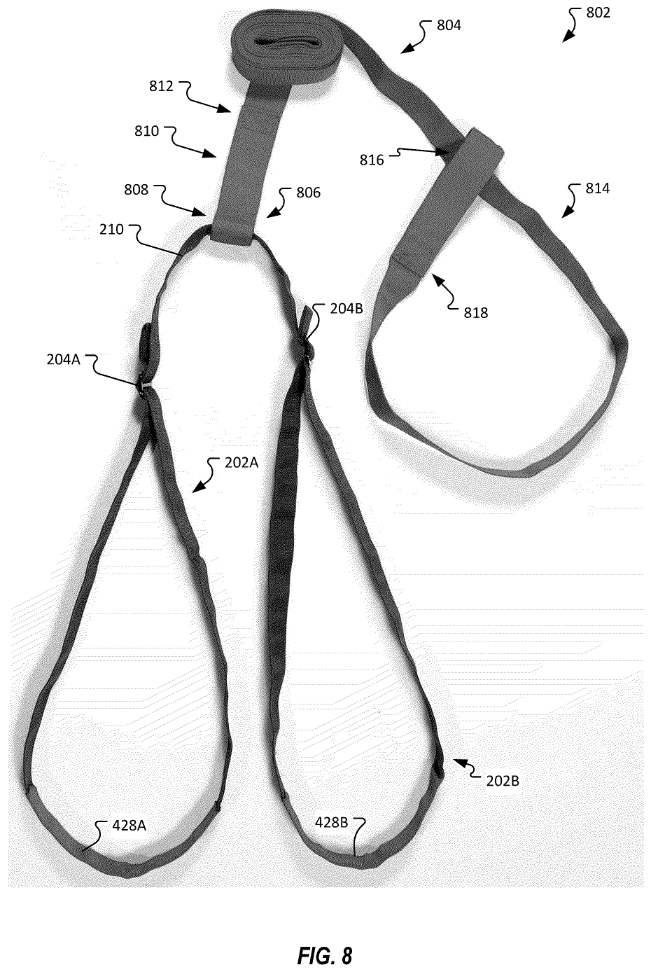

FIG. 8 illustrates yet another example of a tow strap assembly 802, according to examples of the present disclosure. The tow strap assembly 802 may include a body portion 804 configured as flat webbing. The flat webbing material used in body portion 804 typically comprises tightly woven synthetic fibers, such as nylon or polypropylene, providing high tensile strength, abrasion resistance, and minimal elasticity. This construction ensures reliable performance under various towing loads and conditions while offering a lightweight and compact form factor advantageous for storage and portability.

The first connecting portion 806 of the tow strap assembly 802 may include an end loop featuring at least a first opening 808 and optionally a second opening 810. In some aspects, the first opening 808 and/or the second opening 810 may provide flexible attachment methods to various motorcycle components or coupling devices. In some aspects, stitching 812 reinforces various structural points, ensuring durability and maintaining integrity at areas subject to high tension and stress.

In some aspects, the second connecting portion 814 differs from previously described connecting portions (e.g., second connecting portion 714 in FIG. 7) by comprising a single, continuous loop of flat webbing material. In some aspects, the configuration of the second connecting portion 814 may simplify the connection structure, reduce potential points of failure, and enhance ease of use. In some aspects, a single-loop configuration, defining a first opening 816, facilitates attachment and detachment from motorcycles or other connecting elements. Stitching 818 may reinforce this single-loop configuration, providing additional strength and reliability at various junctions.

Adjustable peg loops 202A and 202B with adjustable securing components 204A and 204B and reinforced sections 428A and 428B offer adaptability for securely engaging motorcycle foot pegs, further enhancing the stability and safety of the towing arrangement across diverse motorcycle configurations.

In certain implementations, the fork/frame strap 116 can be about 32 inches long and may feature quarter-turn loops at each end to simplify alignment with a securing component. In addition, these fork/frame or peg straps may comprise tubular webbing (for example, about 1 ¼ inches wide) to facilitate increased performance, with load-rated stitching to resist wear and maintain integrity under high tension. Whether using an elastic bungee-type body portion or a flat webbing configuration, the tow strap assembly 110 can incorporate loops of approximately 5 inches on each end, bar-tacked or similarly stitched at about 2 inches up from the loop to anchor optional peg or fork straps. Depending on user preference and storage requirements, such configurations allow the system to be adapted as a two-piece or three-piece kit.

The disclosure also provides support for a towing assembly for connecting a first motorcycle to a second motorcycle, the towing assembly comprising: a tow strap including a body portion having a first end loop and an opposing second end portion, the body portion being formed of a webbing material, a peg strap assembly threaded through the first end loop, the peg strap assembly including at least one adjustable loop at a distal end, the at least one adjustable loop being configured to securely engage a foot peg of the first motorcycle, and a fork-frame strap portion configured to attach the opposing second end portion of the body portion to a structural component of the second motorcycle. In a first example of the system, the tow strap comprises an elastic band disposed within a webbing sleeve. In a second example of the system, optionally including the first example, the tow strap comprises substantially inextensible flat webbing. In a third example of the system, optionally including one or both of the first and second examples, the peg strap assembly includes two adjustable loops at respective distal ends, each adjustable loop being dimensioned to engage a different foot peg of the first motorcycle. In a fourth example of the system, optionally including one or more or each of the first through third examples, the fork-frame strap portion is integrally formed with the opposing second end portion of the body portion and includes bar-tack stitching at load-bearing junctions. In a fifth example of the system, optionally including one or more or each of the first through fourth examples, the fork-frame strap portion further comprises a coupling device configured to attach to the opposing second end portion of the tow strap. In a sixth example of the system, optionally including one or more or each of the first through fifth examples, the coupling device comprises at least one of a carabiner, a snap hook, or a buckle. In a seventh example of the system, optionally including one or more or each of the first through sixth examples, the peg strap assembly includes at least one protective sleeve arranged over the at least one adjustable loop. In an eighth example of the system, optionally including one or more or each of the first through seventh examples, the fork-frame strap portion is configured to loop around a structural member of the second motorcycle and secure back onto itself. In a ninth example of the system, optionally including one or more or each of the first through eighth examples, the first end loop, peg strap assembly, and fork-frame strap portion are configured to enable towing forces to be transmitted between the first motorcycle and the second motorcycle without contacting one or more wheel assemblies of either motorcycle.

The disclosure also provides support for a kit for towing a second motorcycle behind a first motorcycle, the kit comprising: a tow strap having a body portion with a first end loop and an opposing second end portion, a peg strap assembly adapted to be threaded through the first end loop, the peg strap assembly including at least one adjustable loop configured to couple to a foot peg of the first motorcycle, and a fork-frame strap portion configured to attach the opposing second end portion of the body portion to a structural component of the second motorcycle. In a first example of the system, the tow strap comprises an elastic band enclosed in a tubular webbing sleeve, the tubular webbing sleeve being sized to limit maximum extension of the elastic band. In a second example of the system, optionally including the first example, the peg strap assembly includes two adjustable loops at respective distal ends, each adjustable loop being dimensioned to engage a different foot peg of the first motorcycle. In a third example of the system, optionally including one or both of the first and second examples, the fork-frame strap portion includes at least one of a partial twist or quarter-turn loop, and wherein the at least one of the partial twist or quarter-turn loop reduce twisting when coupled to the opposing second end portion of the tow strap. In a fourth example of the system, optionally including one or more or each of the first through third examples, the opposing second end portion of the tow strap includes bar-tack stitching forming a looped region through which the fork-frame strap portion may be at least one of passed or attached. In a fifth example of the system, optionally including one or more or each of the first through fourth examples, the fork-frame strap portion is detachably secured via a carabiner to the opposing second end portion of the tow strap. In a sixth example of the system, optionally including one or more or each of the first through fifth examples, the system further comprises: at least one protective sleeve disposed on at least one of the peg strap assembly or the fork-frame strap portion.

The disclosure also provides support for a method for towing a second motorcycle behind a first motorcycle, the method comprising: providing a tow strap having a first end loop and an opposing second end portion, threading a peg strap assembly through the first end loop, the peg strap assembly including at least one adjustable loop configured to engage a foot peg of the first motorcycle, securing the at least one adjustable loop around the foot peg by adjusting a securing element to fix the at least one adjustable loop under tension, and attaching the opposing second end portion of the tow strap to a structural component of the second motorcycle via a fork-frame strap portion. In a first example of the method, attaching the opposing second end portion of the tow strap to the structural component includes looping the fork-frame strap portion around a frame component of the second motorcycle and securing it back to the tow strap via a securing component. In a second example of the method, optionally including the first example, securing the at least one adjustable loop around the foot peg includes positioning a protective sleeve between the foot peg and material of the peg strap assembly.

Having described several aspects of at least one embodiment above, it is to be appreciated that various alterations, modifications, and improvements will readily occur to those skilled in the art. Such alterations, modifications, and improvements are intended to be part of this disclosure and are intended to be within the scope of the invention. It is to be appreciated that embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein are for the purpose of description and should not be regarded as limiting. The use herein of “including,” “comprising,” “having,” “containing,” “involving,” and variations thereof is meant to encompass the items listed thereafter and equivalents thereof, as well as additional items. References to “or” may be construed as inclusive so that any terms described using “or” may indicate any of a single, more than one, and all of the described terms. Accordingly, the foregoing description and drawings are by way of example only, and the scope of the invention should be determined from proper construction of the appended claims, and their equivalents.

What is claimed is:

1. A towing assembly for connecting a first motorcycle to a second motorcycle, the towing assembly comprising:
a tow strap including a body portion having a first end loop and an opposing second end portion, the body portion being formed of a webbing material;
a peg strap assembly threaded through the first end loop, the peg strap assembly including at least one adjustable loop at a distal end, the at least one adjustable loop being configured to securely engage a foot peg of the first motorcycle; and
a fork-frame strap portion configured to attach the opposing second end portion of the body portion to a structural component of the second motorcycle.

2. The towing assembly of claim 1, wherein the tow strap comprises an elastic band disposed within a webbing sleeve.

3. The towing assembly of claim 1, wherein the tow strap comprises substantially inextensible flat webbing.

4. The towing assembly of claim 1, wherein the peg strap assembly includes two adjustable loops at respective distal ends, each adjustable loop being dimensioned to engage a different foot peg of the first motorcycle.

5. The towing assembly of claim 1, wherein the fork-frame strap portion is integrally formed with the opposing second end portion of the body portion and includes bar-tack stitching at load-bearing junctions.

6. The towing assembly of claim 1, wherein the fork-frame strap portion further comprises a coupling device configured to attach to the opposing second end portion of the tow strap.

7. The towing assembly of claim 6, wherein the coupling device comprises at least one of a carabiner, a snap hook, or a buckle.

8. The towing assembly of claim 1, wherein the peg strap assembly includes at least one protective sleeve arranged over the at least one adjustable loop.

9. The towing assembly of claim 1, wherein the fork-frame strap portion is configured to loop around a structural member of the second motorcycle and secure back onto itself.

10. The towing assembly of claim 1, wherein the first end loop, peg strap assembly, and fork-frame strap portion are configured to enable towing forces to be transmitted between the first motorcycle and the second motorcycle without contacting one or more wheel assemblies of either motorcycle.

11. A kit for towing a second motorcycle behind a first motorcycle, the kit comprising:
a tow strap having a body portion with a first end loop and an opposing second end portion;
a peg strap assembly adapted to be threaded through the first end loop, the peg strap assembly including at least one adjustable loop configured to couple to a foot peg of the first motorcycle; and
a fork-frame strap portion configured to attach the opposing second end portion of the body portion to a structural component of the second motorcycle.

12. The kit of claim 11, wherein the tow strap comprises an elastic band enclosed in a tubular webbing sleeve, the tubular webbing sleeve being sized to limit maximum extension of the elastic band.

13. The kit of claim 11, wherein the peg strap assembly includes two adjustable loops at respective distal ends, each adjustable loop being dimensioned to engage a different foot peg of the first motorcycle.

14. The kit of claim 11, wherein the fork-frame strap portion includes at least one of a partial twist or quarter-turn loop, and wherein the at least one of the partial twist or quarter-turn loop reduce twisting when coupled to the opposing second end portion of the tow strap.

15. The kit of claim 11, wherein the opposing second end portion of the tow strap includes bar-tack stitching forming a looped region through which the fork-frame strap portion may be at least one of passed or attached.

16. The kit of claim 11, wherein the fork-frame strap portion is detachably secured via a carabiner to the opposing second end portion of the tow strap.

17. The kit of claim 11, further comprising at least one protective sleeve disposed on at least one of the peg strap assembly or the fork-frame strap portion.

18. A method for towing a second motorcycle behind a first motorcycle, the method comprising:
providing a tow strap having a first end loop and an opposing second end portion;
threading a peg strap assembly through the first end loop, the peg strap assembly including at least one adjustable loop configured to engage a foot peg of the first motorcycle;
securing the at least one adjustable loop around the foot peg by adjusting a securing element to fix the at least one adjustable loop under tension; and
attaching the opposing second end portion of the tow strap to a structural component of the second motorcycle via a fork-frame strap portion.

19. The method of claim 18, wherein attaching the opposing second end portion of the tow strap to the structural component includes looping the fork-frame strap portion around a frame component of the second motorcycle and securing it back to the tow strap via a securing component.

20. The method of claim 18, wherein securing the at least one adjustable loop around the foot peg includes positioning a protective sleeve between the foot peg and material of the peg strap assembly.
